(19) United States
(12) Patent Application Publication
(10) Pub. No.: US 2024/0060717 A1
(43) Pub. Date: Feb. 22, 2024

(54) SYSTEM FOR STORING AND PRODUCING ENERGY TO STABILIZE THE POWER NETWORK

(71) Applicant: SAIPEM S.P.A., Milano (IT)

(72) Inventors: Matteo BERRA, Milano (IT); Lorenzo BRUNO, Milano (IT)

(21) Appl. No.: 18/259,838

(22) PCT Filed: Dec. 27, 2021
(86) PCT No.: PCT/IB2021/062336

§ 371 Date: Jun. 29, 2023

(30) Foreign Application Priority Data
Dec. 29, 2020 (IT) 102020000032657

(51) Int. Cl. F25J 3/04

(52) U.S. Cl. CPC F25J 3/04533; F25J 3/04612; F25J 2210/40; F25J 2210/50; F25J 2220/80

(57) ABSTRACT

A system for storing or producing electricity, which allows stabilization of a power network under conditions of excess availability of electricity or lack thereof and for producing liquefied natural gas is provided.

### TECHNICAL FIELD OF THE INVENTION

The present invention finds application in the management of electricity demand peaks or shortages.

### BACKGROUND ART

There are many technologies for storing electricity: electrochemical methods (batteries), mechanical (flywheels, compressed air, accumulation of water at heights), thermodynamic methods (liquefied gas: liquid air, referred to as Liquid Air Energy Storage (LAES)).

Furthermore, it is possible to produce energy from a fuel by sequestering combustion CO₂, through carbon capture techniques from combustion fumes, or through combustion in a synthetic atmosphere consisting mainly of CO₂ and oxygen (oxy-combustion): the fuel and oxygen are converted into CO₂ and water, then removed from the system.

The operation of a turbogas oxy-combustion plant according to the Graz cycle can be described through the following steps:
1) burning a fuel in an appropriate combustor in an atmosphere of CO₂, H₂O, and O₂ at high pressure, with the conversion of the fuel and oxygen to carbon dioxide and water,
2) expanding the combustion gases in a machine which produces power and reduces the temperature of the combustion gases,
3) recovering heat from the exhaust fumes by means of a Rankine steam cycle,
4) further expanding the fumes in a power-producing machine,
5) condensing the water vapor from the fumes expanded in the preceding step,
6) re-compressing the exhaust fumes, consisting of CO₂ and water, through a sequence of compression stages; at the appropriate pressure, the CO₂ produced in the combustion is tapped and sent to the sequestration operations; the remaining part of the exhaust fumes are further compressed until reaching an appropriate temperature, at which an inter-stage refrigeration is performed with the water forming the motor fluid of the Rankine cycle,
7) finally compressing the remaining part of the exhaust gases to combustor pressure,
8) recycling the exhaust gases to the combustor,
9) instead, the water condensed mentioned under 5) is pumped (the excess amount formed in the combustion is instead removed from the system) and pre-heated in the inter-stage refrigeration operation mentioned under 6),
10) then treating it according to known methods to make it suitable for steam generation,
11) then pumping it at high pressure and sending it to the heat recovery mentioned under 3), where it becomes steam,
12) expanding the steam in a turbine up to the pressure of the combustor mentioned under 1), and injected into the latter.

The process of producing O₂ fed to the combustor belongs to the prior art, and cryogenic air distillation is typically employed for large amounts.

An alternative to the Graz cycle, in which a steam Rankine cycle is used which involves the release of large quantities of heat at low temperature and which affects the efficiency of heat recovery, is the Allam cycle in which the elimination of such a Rankine cycle is suggested.

In particular, this comprises:
1) burning a fuel in an appropriate combustor in an atmosphere of CO₂, H₂O, and O₂ at high pressure, with the conversion of the fuel and oxygen to carbon dioxide and water,
2) expanding the combustion gases in a machine which produces power and reduces the temperature of the combustion gases,
3) recovering heat from the exhaust fumes by means of the carbon dioxide recirculated to the combustor mentioned under 1),
4) further cooling the exhaust fumes and separating the condensed water,
5) re-compressing the exhaust fumes, mainly consisting of CO₂ to supercritical pressure,
6) cooling the fumes mentioned under 5) to sub-critical temperature,
7) pumping the liquid carbon dioxide to the appropriate pressure to return it to the combustor mentioned under 1),
(8) heating the CO₂ mentioned under 7) in the thermal recovery operation mentioned under 3).

The process of producing O₂ fed to the combustor belongs to the prior art, and cryogenic air distillation is typically employed for large amounts.

As for LAES technology, a description of the operation thereof is briefly reported here.

In the storage step, a LAES plant uses energy from renewable sources to produce liquid air.

During use, it obtains power from the previously stored liquid air.

The production of liquid air is known in the art.

The energy can be conveniently recovered from the liquid air either through the use of a thermal machine operating between the ambient temperature and the evaporation temperature of the liquid air, which is used as a heat sink or through the following process:
1) the liquid air is pumped at high pressure,
2) it is heated by heat exchange with a return air current,
3) it undergoes a final heating to a temperature close to ambient temperature,
4) it undergoes an expansion up to super-critical pressure through a power-producing machine,
5) part of the expanded air is sent to the exchanger mentioned under 2) above and re-liquefied,
6) the remaining part of the air undergoes further expansion, through a power generating machine, to low pressure, and before being released into the atmosphere, gives the frigories thereof in favor of the recycling current.

The current liquefied under 5) is laminated to the storage pressure: one part will evaporate and be released into the atmosphere after recovering the frigories, while the other part will remain stored.

Some sophisticated systems have been designed to limit the considerable energy expenditure required by the liquefaction of air; they range from the storage of frigories in a solid accumulator, to the coupling of a LAES system to an LNG vaporizer which produces natural gas, as shown for example in patents KR 102147234 B1 and CN 207420649 U.

These patents show the use of liquefied natural gas for liquefying a current of compressed air, using liquefied natural gas which must be imported from the outside; therefore, these systems actually consume liquefied natural gas which has been obtained using non-renewable energy sources.

Prior art document US 2011/100055 describes a “portable” system for producing large quantities of nitrogen and oxygen using a preliminary non-cryogenic step and a cryogenic purification.

Prior art document U.S. Pat. No. 5,832,748 describes a system for the cryogenic production of oxygen with low-purity.

Prior art document U.S. Pat. No. 6,131,407 describes the expansion of natural gas to generate the frigories necessary for the production of liquefied natural gas.

Prior art document CA 2,567,586 describes the cryogenic separation of air by means of a current of liquefied natural gas.

Prior art document US 2014/245779 describes a process for producing liquefied nitrogen in an Air Separation Unit (ASU) and liquefied CO₂ using liquefied natural gas.

### SUMMARY OF THE INVENTION

The authors of the present invention have surprisingly developed a method which includes two steps: generation and storage; in the storage step, electricity and liquefied natural gas stored in the generation step are used to distill air and store liquid oxygen and oxygen-depleted air in liquid form.

During this step, at least a part or all of the liquefied natural gas is vaporized and fed into the network or, alternatively, stored.

In the generation step, a combined oxy-combustion cycle produces electricity, wherein one of the motor fluids for the secondary heat recovery cycle is represented by liquid oxygen-depleted air, which is vaporized at the expense of the natural gas taken from the network, thus transformed in liquefied natural gas.

### OBJECT OF THE INVENTION

In a first object, the present invention describes a process for producing natural gas and for producing liquid oxygen and oxygen-depleted air in liquid form.

In a particular aspect of the invention, such a process is carried out within a method for stabilizing the power network, possibly using the excess electricity to produce said liquid oxygen and said liquid oxygen-depleted air.

In a second object, the present invention describes a process for generating or producing electricity and liquid carbon dioxide and, optionally, also liquid natural gas.

In a particular aspect of the invention, such a process is carried out within a method for stabilizing the power network, in particular, in periods of shortage of supply.

Overall, the present invention thus describes in a third object a method for stabilizing the power network and possibly for producing and storing LNG.

### BRIEF DESCRIPTION OF THE DRAWINGS

FIG. 1 shows the process of the invention according to a first aspect thereof in which electricity is stored (peak shaving) through the storage of liquid oxygen and liquid (oxygen) depleted air.

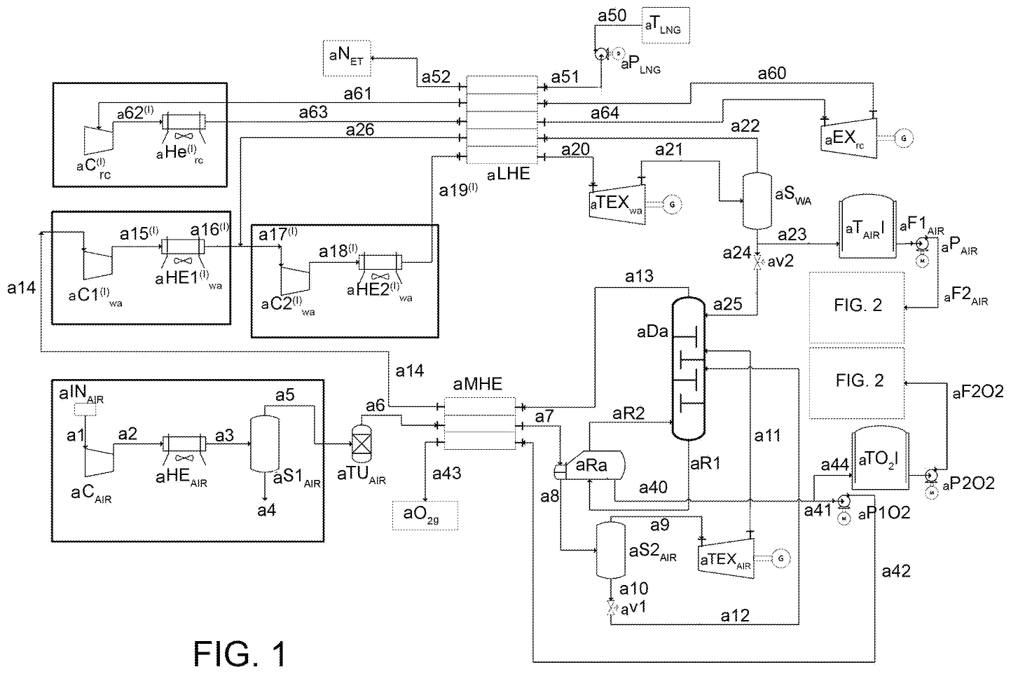

FIG. 2 shows the process of the invention in a second aspect thereof, in which the generation of electricity and possibly of liquefied natural gas is actuated.

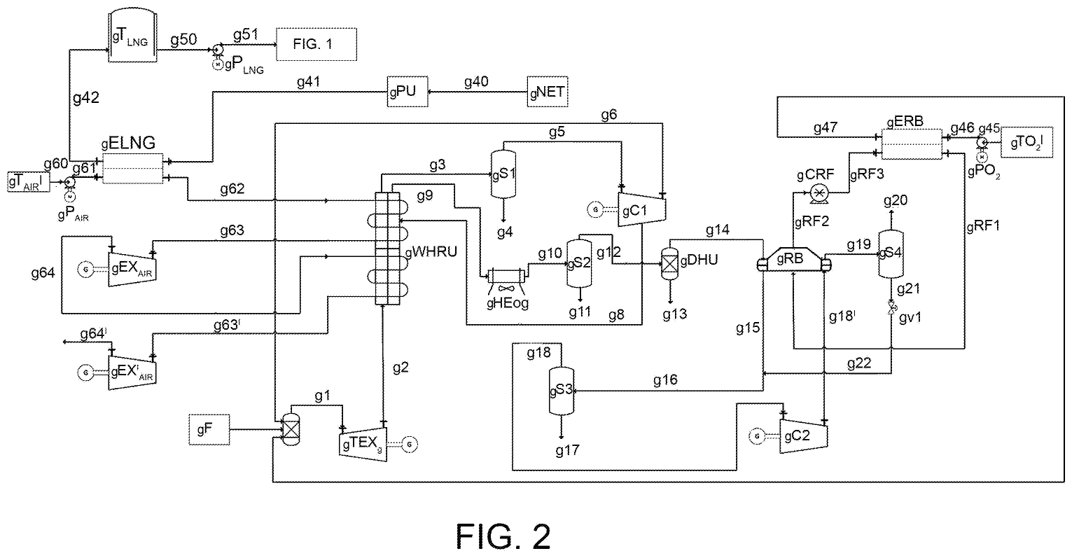

### DETAILED DESCRIPTION OF THE INVENTION

In a first object, the present invention describes a process for producing natural gas and for producing liquid oxygen and liquid oxygen-depleted air.

Such a process comprises steps which involve:
an air cycle,
a refrigeration cycle,
   and possibly a natural gas cycle.

For the purposes of the present invention, the aforementioned cycles are connected to one another by means of one or more heat exchange steps.

In a first aspect, the process of the invention achieves the storage step mentioned above (references to this aspect are preceded for convenience by “ₐ”).

In particular, such a process comprises subjecting an air flow ₐ1 withdrawn from a source ₐINₐᵢᵣ to the steps of:
I) pre-treatment,
II) treatment,
III) heat exchange,
IV) separation, obtaining a flow of oxygen ₐ40 and an oxygen-depleted air flow ₐ13,
Va) obtaining a liquid oxygen flow ₐ44 and a gaseous oxygen flow ₐ43 from said oxygen flow ₐ40,
Vb) obtaining a liquid oxygen-depleted air flow ₐ13 from said oxygen-depleted air flow ₐ23.

More in detail, in such a pre-treatment step I) the air flow ₐ1 is subjected to the steps of:
Ia) compression in a compressor ₐCₐᵢᵣ, thus obtaining a compressed air flow ₐ2,
Ib) cooling said compressed air flow ₐ2 in a cooler ₐHEₐᵢᵣ, thus obtaining a compressed and cooled air flow ₐ3,
Ic) separation in a first separator S1ₐᵢᵣ of a condensed vapor flow ₐ4 from the bottom of said separator S1ₐᵢᵣ and of a compressed and cooled gaseous flow ₐ5 from the head of said separator ₐS1ₐᵢᵣ.

In particular, in step Ib) the cooling is obtained by heat exchange with a cooling fluid, for example represented by air or water.

For the purposes of the present invention, steps Ia), Ib) and Ic) can be repeated several times, until a compressed and cooled gaseous air flow ₐ5 is obtained at the appropriate pressure for the subsequent operations.

The repetition of such steps shall be compatible with the necessary plant complexity and the consequent constructional and operating costs.

According to the treatment step II), the compressed and cooled gaseous flow ₐ5 is subjected to a purification in a Treatment Unit ₐTUₐᵢᵣ for the removal of impurities, thus obtaining a purified air flow ₐ6.

For the purposes of the present invention, such impurities are represented by residual humidity, carbon dioxide, hydrocarbons, among which, in particular, acetylene.

In the subsequent heat exchange step III), the purified air flow ₐ6 is subjected to a step in which it is cooled to a temperature close to the condensation point thereof, with possible partial condensation, obtaining a purified and cooled air flow ₐ7.

Such a cooling is carried out in particular in the exchanger ₐMHE.

In separation step IV) a preliminary step IVa) is carried out, in which the purified and cooled air flow ₐ7 is subjected to a further cooling inside the reboiler ₐRa of a distillation column ₐDa obtaining a partially condensed flow ₐ8.

From said partially condensed flow ₐ8 inside a second separator ₐS2ₐᵢᵣ in a step IVb), a second condensed liquid air flow ₐ10 is separated from the bottom, which is laminated by a first lamination valve ₐV1, thus obtaining a laminated current ₐ12 then fed to the same distillation column ₐDa.

From the head of the second separator ₐS2ₐᵢᵣ, a gaseous flow ₐ9 is instead separated, which is expanded in a turbine ₐTEXₐᵢᵣ generating power and obtaining an expanded flow ₐ11 which is fed to the distillation column ₐDa.

A flow of oxygen-depleted air ₐ13 is obtained from the head of the distillation column ₐDa.

In a preferred aspect of the present invention, said oxygen-depleted air flow ₐ13 has an oxygen content of less than 12% v/v.

Advantageously, thereby, the oxygen content is less than the flammability limit of the liquefied natural gas, contributing to a greater safety of the process and of the plant in which it is carried out.

According to a possible embodiment, a column bottom current ₐR1 is obtained from the bottom of the distillation column ₐDa which is sent to the reboiler ₐRa of the column ₐDa for step IV) to then be recirculated to the bottom of the column as flow ₐR2; equivalent variants of such an embodiment can be implemented by those skilled in the art based on contingent needs.

In step Va), from the reboiler ₐRa a it is further obtained a liquid oxygen flow ₐ40, of which a first portion ₐ41 is pumped into a first oxygen pump ₐP1O₂ thus obtaining a pumped flow ₐ42, which is subjected to a heat exchange step in the exchanger ₐMHE wherein it is heated, obtaining a vaporized (gaseous) oxygen flow ₐ43.

A second portion ₐ44 of the liquid oxygen flow is sent to a liquid oxygen reservoir ₐTO₂₁, in which it is stored and from which a use flow ₐF1O₂ can be withdrawn, which can be pumped into a second oxygen pump ₐP2O₂, thus obtaining a pumped use flow ₐF2O₂.

In step Vb), the oxygen-depleted air flow ₐ13 is subjected to a heat exchange step in the exchanger a MHE, thus obtaining a heated oxygen-depleted air flow ₐ14.

Such a heated oxygen-depleted air flow ₐ14 is then subjected to the steps of:
compression, in a first compressor ₐC1_{wa}, thus obtaining a compressed flow ₐ15,
cooling, in a first cooler ₐHE1_{wa}, thus obtaining a compressed and cooled flow ₐ16.

In particular, the cooling in the first cooler ₐHE1_{wa} is carried out using a refrigerant fluid represented for example by air or water.

The compression and cooling steps can be repeated one or more times depending on needs and taking into account the complexity of the plant and the operating and construction costs.

For example, the compressed and cooled flow ₐ16 can be compressed in a further first compressor ₐC1′_{wa}, thus obtaining a further compressed flow ₐ15′ to be cooled in a further first cooler ₐHE1′_{wa}, thus obtaining a further first compressed and cooled flow ₐ16′.

In accordance with an embodiment of the present invention, said first compressed and cooled flow ₐ16 or said further first compressed and cooled flow ₐ16′ can be rejoined with a heated recycled gas flow a 26, obtained as described below, generating a second flow ₐ17.

Said second flow ₐ17 is compressed in a second compressor ₐC2_{wa} to obtain a second compressed flow ₐ18 which is cooled in a second cooler ₐHE2_{wa}, thus obtaining a second compressed and cooled flow ₐ19.

The compression and cooling steps can be repeated one or more times depending on needs and taking into account the complexity of the plant and the operating and construction costs.

For example, the second compressed and cooled flow ₐ19 can be compressed in a further second compressor ₐC2′_{wa}, thus obtaining a further second compressed flow ₐ18′, which can be cooled in a further second cooler ₐHE2′_{wa}, thus obtaining a further second compressed and cooled flow ₐ19′.

Said further compressed and further cooled flow ₐ19/ₐ19′ is subjected to a heat exchange step in the exchanger ₐLHE with which it is cooled, obtaining an at least partially condensed flow ₐ20.

Said partially condensed flow ₐ20 is expanded in an expander ₐTEX_{wa} generating power and obtaining a further condensed flow a 21.

Inside a separator ₐS_{wa}, a gaseous head flow ₐ22 is separated from said further condensed flow ₐ21 which, after being heated in a heat exchange step in the heat exchanger ₐLHE, generates the heated recycled gas flow ₐ26 mentioned above.

A liquid oxygen-depleted air flow ₐ23 is obtained from the bottom of the separator ₐS_{wa}, which is sent to a tank ₐTₐᵢᵣ to be stored.

A flow ₐF1ₐᵢᵣ is obtained from such a tank ₐTₐᵢᵣ which, after being pumped by a pump ₐPₐᵢᵣ, forms a use flow of pumped liquid oxygen-depleted air ₐF2ₐᵢᵣ.

A portion of the oxygen-depleted air flow ₐ24 is laminated by a second lamination valve ₐV2, thus obtaining a laminated flow ₐ25 at the head pressure of the distillation column ₐDa and fed thereto.

For the purposes of the present invention, the frigories necessary for the heat exchange steps in the exchanger ₐLHE can also be further provided by a refrigeration cycle.

According to an aspect of the present invention, such a refrigeration cycle is represented by a liquefied natural gas cycle.

In particular, a cooled and expanded liquefied natural gas flow ₐ60 obtained from an expansion step, for example in a liquefied natural gas expander ₐEX_{rc}, carries out a heat exchange by releasing the frigories thereof by heat exchange in the exchanger ₐLHE to the further compressed and further cooled flow ₐ19, generating a heated current ₐ61.

The heated current ₐ61 at the outlet of the exchanger LHE is compressed in a compressor of the refrigeration cycle ₐC_{rc}, thus obtaining a compressed flow ₐ62 which is then cooled in a cooler of the refrigeration cycle ₐHE_{rc} obtaining a compressed and cooled flow ₐ63.

According to a particular aspect of the present invention, the compression and cooling in the refrigerant cycle can be repeated several times in a further compressor of the refrigeration cycle ₐC′_{rc}, thus obtaining a further compressed flow ₐ62′, possibly cooled in a further cooler ₐHE′r_{c} of the refrigeration cycle, until a cryogenic flow ₐ63 is obtained; the repetition of such steps depends on the needs and complexity of the plant and the construction and operating costs.

Said cryogenic flow ₐ63 is then further cooled by heat exchange in the heat exchanger ₐLHE, thus obtaining a further cooled flow ₐ64, which, in a preferred aspect, is then expanded in the refrigeration cycle (or liquefied natural gas) expander ₐEX_{rc} with power production.

According to a particular aspect of the present invention, a further liquefied natural gas flow a 50 in output from a dedicated tank ₐT_{LNG} can be sent to the heat exchanger ₐLHE and pumped by a liquefied natural gas pump P_{LNG}, thus obtaining a further pumped liquefied natural gas flow ₐ51.

The pumped liquefied natural gas flow ₐ51 heats up and vaporizes in the exchanger ₐLHE, creating a further natural gas flow ₐ52 fed to the network.

Thus for the purposes of the present invention, heat exchanges are carried out between the purified air flow ₐ6, which is cooled to a cooled purified air flow ₐ7 (step III), the oxygen-depleted air flow ₐ13, which is heated to a heated oxygen-depleted air flow ₐ14 (step Vb), and the pumped oxygen flow ₐ42, which is heated and vaporized providing the vaporized oxygen flow ₐ43.

In particular, said heat exchanges are carried out in the exchanger ₐMHE.

Thus for the purposes of the present invention, heat exchanges are carried out between the second compressed and cooled flow ₐ19 (or a further second compressed and cooled flow 19′), which is cooled to an at least partially condensed flow ₐ20, the gaseous head flow ₐ22, which is heated providing the heated gaseous recycled flow ₐ26, the cryogenic flow ₐ63, which is cooled to a further cooled flow ₐ64, the cooled and expanded natural gas flow ₐ60 providing the heated flow ₐ61, and possibly also between the pumped liquefied natural gas flow ₐ51, which is heated and vaporized giving the further natural gas flow ₐ52.

In particular, said heat exchanges are carried out in the exchanger ₐLHE.

For the purposes of the present invention, the steps of the process described above are carried out using electricity.

In a second object, the present invention describes a process for producing electricity and liquid carbon dioxide; optionally and preferably also liquid natural gas.

Such a process comprises steps which involve:
an oxygen-depleted air cycle,
a cycle by means of a refrigerant fluid,
an oxygen cycle,
   and possibly a liquefied natural gas cycle.

For the purposes of the present invention, the aforementioned cycles are connected to one another by means of one or more heat exchange steps.

Such a process achieves the generation step mentioned above (references to this aspect are preceded by the “_{g}”).

In particular, the combustion of a fuel _{g}F in a combustor _{g}COMB is obtained in a step A) in the presence of a carbon dioxide-rich recirculation flow _{g}6 and a gaseous oxygen flow _{g}47.

The combustion produces a combusted flow _{g}1 consisting mainly of CO₂ and water at high pressure and temperature, which is expanded in a power-producing expander _{g}TEX.

Preferably, the expansion is carried out up to almost atmospheric pressure, while the temperature is lowered to about 700° C.

The expanded combusted flow _{g}2 thus obtained in a step B) is subjected to a heat exchange in a Heat Recovery Unit _{g}WHRU in which it is cooled, obtaining an expanded and cooled flow _{g}3.

For the purposes of the present invention, the cooling is preferably carried out up to about 90° C.

Inside the Heat Recovery Unit _{g}WHRU, the heat exchange of step B) is carried out with a pumped oxygen-depleted air flow _{g}61 or pumped and heated flow _{g}62 and possibly also with a heated and expanded air flow _{g}64, which circulate within an air cycle, as it will be described below.

In a step C) the expanded and cooled flow _{g}3 is subjected to a separation step in a first separator _{g}S1 from the bottom of which a first portion _{g}4 of condensed water vapor is obtained.

A first gas flow _{g}5 is obtained from the head of said first separator _{g}S1, which is then compressed in a first compressor _{g}C1, from which a CO₂-rich recirculation flow _{g}6 is obtained, which is recirculated to the combustor _{g}COMB in order to decrease the combustion temperature.

A compressed flow _{g}8 is also obtained from the first compressor _{g}C1, which is sent to the Heat Recovery Unit _{g}WHRU, thus obtaining a cooled compressed flow _{g}9.

In a preferred aspect, the compressed flow _{g}8 is withdrawn from the first compressor _{g}C1 at a pressure of about 10 barg.

Inside the Heat Recovery Unit _{g}WHRU, the heat exchange is carried out with a pumped oxygen-depleted air flow _{g}61 or pumped and heated flow _{g}62, which circulates within an air cycle, as it will be described below.

In the case wherein the cooling inside the Heat Recovery Unit _{g}WHRU does not reach ambient temperature, it is possible to further cool the cooled compressed flow _{g}9 in a cooler _{g}HE_{ag}, by means of a refrigerant fluid represented for example by air or water, obtaining a further cooled flow _{g}10.

The cooled compressed flow _{g}9 or the further cooled flow _{g}10 is subjected to a separation step D) in a second separator _{g}S2 from whose bottom a second portion _{g}11 of condensed water vapor is obtained.

A flow _{g}12 with a main composition of carbon dioxide is obtained from the head of the second separator _{g}S2, which is subjected to a treatment step E) in a Dehydration Unit _{g}DHU wherein it is dehydrated by separating a flow from the bottom _{g}13 mainly consisting of condensed water and a dehydrated flow _{g}14 from the head.

For the purposes of the present invention, such a dehydration is carried out up to less than about 500 ppm and preferably up to less than about 50 ppm of water.

The dehydrated flow _{g}14 obtained is then subjected to a cooling step F) in a refrigerant bath _{g}RB, thus obtaining a cooled dehydrated flow _{g}15.

A second laminate flow with a main composition of CO_{2 g}22 obtained as described below is joined to the cooled dehydrated flow _{g}15, thus obtaining a combined flow with a main composition of CO_{2 g}16.

In a third separator _{g}S3 from such a combined flow with a main composition of CO_{2 g}16 a flow of liquid CO_{2 g}17 is separated from the bottom and a gaseous release flow _{g}18 is separated from the head.

In particular, such a liquid CO₂ flow _{g}17 consists of at least 95% CO₂.

In a step G) such a gaseous release flow _{g}18 can be compressed in a second compressor _{g}C2, thus obtaining a compressed gaseous release flow _{g}18′.

The gaseous release flow _{g}18 or the compressed gaseous release flow _{g}18′ is sent to the refrigerant bath _{g}RB wherein it is cooled and partially condensed, obtaining a partially condensed release flow _{g}19.

A final gaseous release flow _{g}20 is separated in a step H) from such a partially condensed release flow _{g}19 in a fourth separator _{g}S4 which is released into the atmosphere, possibly after being further treated to reduce the carbon content thereof.

In particular, such a gaseous release flow _{g}20 mainly comprises argon, nitrogen, carbon dioxide and oxygen.

Instead, a recovery liquid flow _{g}21 is obtained from the bottom of the fourth separator S4, which is laminated by a first lamination valve _{g}V1, thus obtaining a laminated flow with a main composition of CO_{2 g}22 to the pression of the third separator _{g}S3 and it is reunited with the cooled dehydrated flow _{g}15 as described above.

For the purposes of the present invention, the refrigerant bath _{g}RB operates on a refrigerant cycle in which a refrigerant fluid RF circulates.

In particular, such a refrigerant fluid is selected from the group comprising CF4, argon, R32, R41, R125 or another refrigerant fluid known in the field.

To this purpose, inside the refrigerant bath _{g}RB, the dehydrated flow _{g}14, as well as the gaseous release flow _{g}18 or the compressed gaseous release flow _{g}18′, are cooled by a cooled flow _{g}RF1 of the refrigerant fluid, which heats up to obtain a heated refrigerant fluid flow _{g}RF2.

Such a heated refrigerant fluid flow RF2 is pumped into a refrigerant fluid cycle blower _{g}CRF providing a pumped refrigerant fluid flow _{g}RF3, which is then cooled in the heat exchanger by an oxygen cycle _{g}Erb, thus obtaining a cooled refrigerant fluid flow _{g}RF1.

In particular, the oxygen cycle originates from a tank _{g}TO₂ where liquid oxygen is stored.

In fact, a liquid oxygen flow _{g}45 originates from the tank _{g}TO₂ which is pumped by an oxygen pump _{g}PO₂, thus obtaining a pumped liquid oxygen flow _{g}46.

Such a pumped liquid oxygen flow _{g}46 carries out a heat exchange step in the oxygen cycle exchanger _{g}Erb, transferring the frigories thereof to the pumped refrigerant fluid flow _{g}RF3, thus obtaining a gaseous oxygen flow _{g}47.

The gaseous oxygen flow _{g}47 thus obtained is sent to the combustor _{g}COMB as described above.

In an aspect of the invention, the oxygen flow sent to the combustor _{g}COMB is characterized by high purity >95%.

Therefore, for the purposes of the present invention, the dehydrated flow _{g}14 is indirectly cooled by the pumped liquid oxygen flow _{g}46, through the refrigerant fluid in the refrigerant bath _{g}RB.

As reported above, inside the Heat Recovery Unit _{g}WHRU, heat exchanges are carried out with one or more oxygen-depleted air flows circulating within an oxygen-depleted air circuit.

In particular, from an oxygen-depleted air tank _{g}Tₐᵢᵣ, an oxygen-depleted air flow _{g}60 is withdrawn which is pumped by a pump _{g}Pₐᵢᵣ thus obtaining a pumped oxygen-depleted air flow _{g}61.

In a preferred aspect, the pumping is carried out up to a pressure of about 80 barg.

Such a pumped oxygen-depleted air flow _{g}61, before being sent to the Heat Recovery Unit _{g}WHRU, can perform a heat exchange in a natural gas exchanger _{g}ELNG with a purified natural gas flow _{g}41 obtained as described below, obtaining a pumped heated oxygen-depleted air flow _{g}62.

The oxygen-depleted air flow _{g}61 or the heated oxygen-depleted air flow _{g}62 is sent to the Heat Recovery Unit _{g}WHRU in which it performs a heat exchange with the compressed flow _{g}8 and the expanded combusted flow _{g}2, thus obtaining a further heated oxygen-depleted air flow _{g}63.

In an embodiment of the invention, such a further heated oxygen-depleted air flow _{g}63 can optionally be expanded in a first expander _{g}EXₐᵢᵣ with power generation, obtaining a further heated expanded oxygen-depleted air flow _{g}64.

Such a further heated expanded oxygen-depleted air flow _{g}64 can be sent again to the Heat Recovery Unit _{g}WHRU for further heat exchange with the expanded combusted flow _{g}2, thus obtaining an even further heated oxygen-depleted expanded air flow _{g}63′.

In a preferred aspect of the present invention, the further heated oxygen-depleted air flow _{g}63 or the even further heated expanded oxygen-depleted air flow _{g}63′ exits the Heat Recovery Unit _{g}WHRU with a temperature of about 450-500° C.

Before being released into the atmosphere, it can possibly be further expanded in a further expander _{g}EX′ₐᵢᵣ with power generation, achieving an oxygen-depleted release air flow _{g}64′.

Alternatively, such an oxygen-depleted release air flow _{g}64′ can be used in the regeneration of the Air Treatment Unit (_{g}TUair) or in the Natural Gas Purification Unit (_{g}PU) or in the carbon dioxide Dehydration Unit (_{g}DHU).

According to an embodiment of the present invention reported above, the pumped oxygen-depleted air flow _{g}61 can be heated in a liquefied natural gas heat exchanger _{g}ELNG by a purified natural gas flow _{g}41 obtained from a natural gas Purification Unit _{g}PU operating on an initial natural gas flow _{g}40 taken from the network _{g}Net, normally at a pressure of about 70 barg.

In the Purification Unit _{g}PU the initial natural gas flow _{g}40 is treated according to methods known in the field in order to (i) reduce its water content, preferably below 500 ppm of water and even more preferably below 50 ppm and/or (ii) to reduce its sulfur content, preferably below 500 ppm of sulfur and even more preferably below 10 ppm and/or (iii) to reduce its carbon dioxide content, preferably below 500 ppm of carbon dioxide and even more preferably below 50 ppm.

After the heat exchange step in the exchanger g ELNG, the condensed natural gas flow _{g}42 obtained is sent to a tank _{g}TLNG wherein it is properly stored.

According to the need, a liquefied natural gas flow _{g}50 can be taken from such a tank _{g}TLNG, which can be pumped by a liquefied natural gas pump _{g}P_{LNG} resulting in a pumped liquefied natural gas flow _{g}51.

For the purposes of the present invention, the liquid oxygen-depleted air flow employed in the heat exchange step in the exchanger _{g}ELNG for cooling the purified natural gas flow _{g}41 and in the heat exchange with the expanded combusted flow _{g}2 in the Heat Recovery Unit (_{g}WHRU) is the liquid oxygen-depleted air obtained from the storage step and, in particular, from the separation step Vb) in the separator ₐS_{wa} of the oxygen-depleted air cycle and stored in the tank ₐTₐᵢᵣ.

For the purposes of the present invention, the liquid oxygen used in the heat exchange step in the exchanger _{g}Erb of the liquid oxygen cycle for cooling the pumped refrigerant fluid flow _{g}RF3 is the liquid oxygen ₐ40 obtained from the generation step and, in particular, output the reboiler ₐRa of the distillation column ₐDa and (or the portion ₐ44 thereof) stored in the tank ₐTO₂.

For the purposes of the present invention, the liquefied natural gas obtained after the heat exchange with oxygen-depleted air is stored within an appropriate tank _{g}ILNG, and, after being taken as a flow _{g}50 and pumped giving the pumped flow _{g}51, can be used to supply the additional refrigeration units necessary for the heat exchange carried out in the heat exchanger ₐLHE of the storage process described above.

The liquid or gaseous products obtained in accordance with the storage step and with the generation step according to the present invention are stored in appropriate tanks which coincide with each other; in other words, the liquefied natural gas tank (T_{LNG}), the liquid oxygen-depleted air tank (T_{AIR}), the liquid oxygen tank (T_{O2}) of the storage step coincide with the corresponding tanks of the generation (or production) step.

For the purposes of the present invention, in the above description, the pressure values are preferably to be understood as follows:
LNG: 5-150 barg, approximately, and preferably 70 barg;
oxygen and the recycling current to the combustor: 8-450 barg, approximately, and preferably 35 barg;
oxygen-depleted air: 10-400 barg, approximately, and preferably 150 barg;
dehydrated carbon dioxide: it is between triple point pressures and the critical pressure of CO₂.

In light of the above, it is apparent that the processes described are integrated and connected to one another.

In particular, the first process (“STORAGE”) is preferably carried out in a condition of electricity supply exceeding demand (excess) and allows the preparation and storage of liquefied oxygen-depleted air, of liquefied oxygen; as well as the production of natural gas to be introduced into the network.

In a particular aspect of the invention, the first process is carried out within a method for stabilizing the power network, in particular in situations of excess of electricity.

Such a method comprises carrying out the first process using an amount of electricity exceeding the demand.

Furthermore, the second process (“GENERATION”) is preferably carried out under conditions of demand for electricity with respect to demands (shortage) and allows the production of electricity in several steps, as well as the preparation and storage of liquefied natural gas.

In a particular aspect of the invention, the second process is carried out in the context of a method for stabilizing the power network, in particular, in periods of under-supply.

Such a method comprises carrying out the second process using a storage of liquid (oxygen) depleted air and liquid oxygen stored under conditions of excess electricity or, as described above, by means of a “STORAGE” process.

In a third object of the invention, a method for stabilizing the power network is described, comprising implementing the “STORAGE” process and the “GENERATION” process according to the conditions and availability of electricity, advantageously further leading to the production and storage of LNG.

From the description provided above, the several advantages offered by the present invention will be apparent to those skilled in the art.

The method described by the present invention allows high efficiency; for example, 90% with respect to fuel, 45% overall efficiency (i.e., taking into account all the forms of energy fed into the system).

Furthermore, the method is capable of stabilizing the power network by absorbing excess energy or by introducing produced energy.

The method can also conveniently produce liquefied natural gas and gaseous oxygen at high pressure.

The method described by the present invention allows not releasing carbon dioxide into the environment, allowing the implementation of an environmentally sustainable process.

Overall, the method comprises processes which are simpler, from a technical point of view, than the sum of the other processes which lead to the same results, such as oxy-combustion and LAES technologies, for example also due to the use of a single distillation column.

What is claimed is:

1-17. (canceled)

18. A process for producing liquid oxygen and liquid oxygen-depleted air, and possibly natural gas, said process using electricity said process comprising subjecting an air flow withdrawn from a source to the steps of:
I) pre-treatment,
II) treatment,
III) heat exchange,
IV) separation, wherein a preliminary step IVa) is carried out, in which a purified and cooled air flow is subjected to cooling inside a reboiler of a distillation column, obtaining a partially condensed flow from which, in a step IVb), a second condensed liquid air flow is separated within a second separator, from the bottom, and laminated by a first lamination valve, obtaining a partially vaporized current that is fed to the distillation column, and a gaseous flow is separated from a head of said second separator and expanded in a turbine with power generation, obtaining an expanded flow that is fed to the distillation column, obtaining an oxygen flow from the reboiler, a second portion of which is sent to a tank, and an oxygen-depleted air flow is obtained from a head of said distillation column,
Va) obtaining a liquid oxygen flow and a gaseous oxygen flow from said oxygen flow,
Vb) obtaining a liquid oxygen-depleted air flow from said oxygen-depleted air flow, wherein in step Vb), the oxygen-depleted air flow is subjected to a heat exchange step, obtaining a heated oxygen-depleted air flow, which is subjected to one or more steps of:
compression, obtaining a compressed flow,
cooling, obtaining a compressed and cooled flow, to which a heated recycled gas flow is added, obtaining a second flow, which is
compressed, obtaining a second compressed flow, which is cooled, obtaining a further compressed and further cooled flow, which is
subjected to a heat exchange step in a heat exchanger with which it is cooled, obtaining an at least partially condensed flow, which is
expanded in an expander, obtaining a further condensed flow and with power generation, from which
inside a separator, a gaseous head flow which, after being heated in a heat exchange step within the heat exchanger, provides the heated recycled gas flow and, from the bottom of said separator, the liquid oxygen-depleted air flow which is sent to a tank of liquid oxygen-depleted air, are separated, wherein the heat exchange steps in the heat exchanger are carried out using frigories of a refrigeration cycle that uses liquefied natural gas, and
wherein
in pre-treatment step I) the air flow is subjected to the steps of:
Ia) compression in a compressor, obtaining a compressed air flow,
Ib) cooling of said compressed air flow in a cooler, obtaining a compressed and cooled air flow,
Ic) separation in a first separator of a condensed vapor flow from the bottom of said separator and of a compressed and cooled gaseous flow from a head of said separator.

19. The process of claim 18, wherein in step II), the compressed and cooled gaseous flow is subjected to purification in a treatment unit for removal of impurities, thus obtaining a purified air flow.

20. The process of claim 19, wherein in step III) the purified air flow is subjected to a heat exchange step with which the purified air flow is cooled, thus obtaining a purified and cooled air flow.

21. The process of claim 18, wherein the heat exchange step in the heat exchanger is carried out by further using frigories of a liquefied natural gas flow.

22. A method for stabilizing a power network, comprising carrying out a process according to claim 18, wherein available electricity from the power network is used.

23. A process for producing electricity and liquid carbon dioxide and possibly liquid natural gas, comprising the steps of:
A) combusting a fuel flow in presence of a CO₂-rich recirculation flow and a gaseous oxygen flow, obtaining a flow mainly consisting of CO₂ and water at high pressure and temperature, which is expanded in an expander with power production,
B) subjecting to heat exchange the expanded flow thus obtained, obtaining an expanded and cooled flow,
C) separating, in a first separator, a first bottom portion of condensed water vapor and a first gaseous flow, which is then compressed in a first compressor, from which said CO₂-rich recirculation flow is obtained, which is recirculated to a combustor, and a compressed flow which is cooled, thus obtaining a cooled compressed flow,
D) optionally further cooling the cooled compressed flow in a cooler by a refrigerant fluid, obtaining a further cooled flow, separating in a second separator said cooled compressed flow or the further cooled flow, from the bottom of which a second portion of condensed water vapor is obtained, and from a head of which a flow mainly consisting of CO₂ is obtained,
E) subjecting said flow mainly consisting of CO₂ to dehydration, obtaining a dehydrated flow,
F) cooling said dehydrated flow, thus obtaining a cooled dehydrated flow, to which a second flow mainly consisting of CO₂ is added, thus obtaining a combined flow mainly consisting of CO₂, from which in a third separator a liquid CO₂ flow is separated from the bottom, and a gaseous release flow from the head,
G) compressing and cooling said gaseous release flow, obtaining a partially condensed release flow, and
H) separating, in a fourth separator, from said partially condensed release flow, a final gaseous release flow from the head and the second flow mainly consisting of CO₂ from the bottom,
wherein step B) is carried out by frigories supplied by a liquid oxygen-depleted air flow, and
wherein step F) is carried out by frigories supplied by the refrigerant fluid which is cooled by a liquid oxygen flow, thus obtaining said gaseous oxygen flow.

24. The process of claim 23, wherein a pumped oxygen-depleted air flow is heated by a purified natural gas flow obtained by purifying a natural gas flow, obtaining a liquefied natural gas flow and a pumped heated oxygen-depleted air flow.

25. A method for stabilizing a power network, comprising carrying out a process according to claim 23, wherein an amount of electricity is produced, which the power network is lacking.

26. The method of claim 25, wherein said process is carried out using liquid oxygen-depleted air obtained by a process for producing liquid oxygen and liquid oxygen-depleted air, and possibly natural gas, said process using electricity said process comprising subjecting an air flow withdrawn from a source to the steps of:
I) pre-treatment,
II) treatment,
III) heat exchange,
IV) separation, wherein a preliminary step IVa) is carried out, in which a purified and cooled air flow is subjected to cooling inside a reboiler of a distillation column, obtaining a partially condensed flow from which, in a step IVb), a second condensed liquid air flow is separated within a second separator, from the bottom, and laminated by a first lamination valve, obtaining a partially vaporized current that is fed to the distillation column, and a gaseous flow is separated from a head of said second separator and expanded in a turbine with power generation, obtaining an expanded flow that is fed to the distillation column, obtaining an oxygen flow from the reboiler, a second portion of which is sent to a tank, and an oxygen-depleted air flow is obtained from a head of said distillation column,
Va) obtaining a liquid oxygen flow and a gaseous oxygen flow from said oxygen flow,
Vb) obtaining a liquid oxygen-depleted air flow from said oxygen-depleted air flow, wherein in step Vb), the oxygen-depleted air flow is subjected to a heat exchange step, obtaining a heated oxygen-depleted air flow, which is subjected to one or more steps of:
compression, obtaining a compressed flow,
cooling, obtaining a compressed and cooled flow, to which a heated recycled gas flow is added, obtaining a second flow, which is
compressed, obtaining a second compressed flow, which is cooled, obtaining a further compressed and further cooled flow, which is
subjected to a heat exchange step in a heat exchanger with which it is cooled, obtaining an at least partially condensed flow, which is
expanded in an expander, obtaining a further condensed flow and with power generation, from which
inside a separator, a gaseous head flow which, after being heated in a heat exchange step within the heat exchanger, provides the heated recycled gas flow and, from the bottom of said separator, the liquid oxygen-depleted air flow which is sent to a tank of liquid oxygen-depleted air, are separated, wherein the heat exchange steps in the heat exchanger are carried out using frigories of a refrigeration cycle that uses liquefied natural gas, and
wherein
in pre-treatment step I) the air flow is subjected to the steps of:
Ia) compression in a compressor, obtaining a compressed air flow,
Ib) cooling of said compressed air flow in a cooler, obtaining a compressed and cooled air flow,
Ic) separation in a first separator of a condensed vapor flow from the bottom of said separator and of a compressed and cooled gaseous flow from a head of said separator.

27. The method of claim 25, wherein for cooling a compressed refrigerant fluid in step F) of said process a liquid oxygen is used, the liquid oxygen being obtained according to a process for producing liquid oxygen and liquid oxygen-depleted air, and possibly natural gas, said process using electricity said process comprising subjecting an air flow withdrawn from a source to the steps of:
I) pre-treatment,
II) treatment,
III) heat exchange,
IV) separation, wherein a preliminary step IVa) is carried out, in which a purified and cooled air flow is subjected to cooling inside a reboiler of a distillation column, obtaining a partially condensed flow from which, in a step IVb), a second condensed liquid air flow is separated within a second separator, from the bottom, and laminated by a first lamination valve, obtaining a partially vaporized current that is fed to the distillation column, and a gaseous flow is separated from a head of said second separator and expanded in a turbine with power generation, obtaining an expanded flow that is fed to the distillation column, obtaining an oxygen flow from the reboiler, a second portion of which is sent to a tank, and an oxygen-depleted air flow is obtained from a head of said distillation column,
Va) obtaining a liquid oxygen flow and a gaseous oxygen flow from said oxygen flow,
Vb) obtaining a liquid oxygen-depleted air flow from said oxygen-depleted air flow, wherein in step Vb), the oxygen-depleted air flow is subjected to a heat exchange step, obtaining a heated oxygen-depleted air flow, which is subjected to one or more steps of:
compression, obtaining a compressed flow,
cooling, obtaining a compressed and cooled flow, to which a heated recycled gas flow is added, obtaining a second flow, which is
compressed, obtaining a second compressed flow, which is cooled, obtaining a further compressed and further cooled flow, which is
subjected to a heat exchange step in a heat exchanger with which it is cooled, obtaining an at least partially condensed flow, which is
expanded in an expander, obtaining a further condensed flow and with power generation, from which
inside a separator, a gaseous head flow which, after being heated in a heat exchange step within the heat exchanger, provides the heated recycled gas flow and, from the bottom of said separator, the liquid oxygen-depleted air flow which is sent to a tank of liquid oxygen-depleted air, are separated, wherein the heat exchange steps in the heat exchanger are carried out using frigories of a refrigeration cycle that uses liquefied natural gas, and
wherein
in pre-treatment step I) the air flow is subjected to the steps of:
Ia) compression in a compressor, obtaining a compressed air flow,
Ib) cooling of said compressed air flow in a cooler, obtaining a compressed and cooled air flow,
Ic) separation in a first separator of a condensed vapor flow from the bottom of said separator and of a compressed and cooled gaseous flow from a head of said separator.

28. The method of claim 22, wherein the liquid oxygen-depleted air flow is pumped by an oxygen-depleted air pump, obtaining a pumped oxygen-depleted air flow, which is heated by heat exchange with a natural gas flow obtained according to a process for producing liquid oxygen and liquid oxygen-depleted air, and possibly natural gas, said process using electricity said process comprising subjecting an air flow withdrawn from a source to the steps of:
I) pre-treatment,
II) treatment,
III) heat exchange,
IV) separation, wherein a preliminary step IVa) is carried out, in which a purified and cooled air flow is subjected to cooling inside a reboiler of a distillation column, obtaining a partially condensed flow from which, in a step IVb), a second condensed liquid air flow is separated within a second separator, from the bottom, and laminated by a first lamination valve, obtaining a partially vaporized current that is fed to the distillation column, and a gaseous flow is separated from a head of said second separator and expanded in a turbine with power generation, obtaining an expanded flow that is fed to the distillation column, obtaining an oxygen flow from the reboiler, a second portion of which is sent to a tank, and an oxygen-depleted air flow is obtained from a head of said distillation column,
Va) obtaining a liquid oxygen flow and a gaseous oxygen flow from said oxygen flow,
Vb) obtaining a liquid oxygen-depleted air flow from said oxygen-depleted air flow, wherein in step Vb), the oxygen-depleted air flow is subjected to a heat exchange step, obtaining a heated oxygen-depleted air flow, which is subjected to one or more steps of:
compression, obtaining a compressed flow,
cooling, obtaining a compressed and cooled flow, to which a heated recycled gas flow is added, obtaining a second flow, which is
compressed, obtaining a second compressed flow, which is cooled, obtaining a further compressed and further cooled flow, which is
subjected to a heat exchange step in a heat exchanger with which it is cooled, obtaining an at least partially condensed flow, which is
expanded in an expander, obtaining a further condensed flow and with power generation, from which
inside a separator, a gaseous head flow which, after being heated in a heat exchange step within the heat exchanger, provides the heated recycled gas flow and, from the bottom of said separator, the liquid oxygen-depleted air flow which is sent to a tank of liquid oxygen-depleted air, are separated, wherein the heat exchange steps in the heat exchanger are carried out using frigories of a refrigeration cycle that uses liquefied natural gas, and
wherein
in pre-treatment step I) the air flow is subjected to the steps of:
Ia) compression in a compressor, obtaining a compressed air flow,
Ib) cooling of said compressed air flow in a cooler, obtaining a compressed and cooled air flow,
Ic) separation in a first separator of a condensed vapor flow from the bottom of said separator and of a compressed and cooled gaseous flow from a head of said separator.
